(19) United States
(12) Patent Application Publication
(10) Pub. No.: US 2023/0033505 A1
(43) Pub. Date: Feb. 2, 2023

(54) BATTERY MODULE THERMAL ISOLATION

(71) Applicant: Rivian IP Holdings, LLC, Plymouth, MI (US)

(72) Inventors: Graham Lloyd Feltham, Garden City, MI (US); Travis Cournoyer, Redondo Beach, CA (US)

(21) Appl. No.: 17/387,907

(22) Filed: Jul. 28, 2021

(51) Int. Cl. H01M 50/249; B60R 16/033; H01M 50/204; H01M 50/289; H01M 50/30; H01M 50/271

(52) U.S. Cl. CPC H01M 50/249; B60R 16/033; H01M 50/204; H01M 50/289; H01M 50/394; H01M 50/271

(57) ABSTRACT

Systems and methods are presented herein for isolating individual battery modules of a battery container in response to a thermal runaway event using intumescent material. A pair of opposing side walls are connected by crossmembers which at least partially define bays and/or enclosures for battery modules. A gap resides between two of the bays and/or enclosures and intumescent material is applied proximate to the gap. The intumescent material is configured to expand when exposed to heat. When a thermal runaway event is caused by the operation of a battery module within an enclosure defined by the crossmembers, the intumescent material expands to at least partially seal each bay and/or enclosure to isolate the individual battery module causing the thermal runaway event and prevent the spread of the heat to battery modules in other bays and/or enclosures.

### INTRODUCTION

The present disclosure is directed to systems and methods for isolating individual batteries within a battery pack in response to a thermal runaway event, and more particularly, to systems and methods that isolate individual batteries within a battery pack including intumescent materials.

### SUMMARY

Approaches for providing power to vehicles include having a collection of individual battery cells interconnected to create battery modules which are arranged within a battery pack. As the battery cells provide power to the various systems within vehicles, they may collectively generate heat within the battery modules. Vents or valves can be used to address the heat buildup within module bays and/or enclosures of individual battery modules in an effort to prevent the heat buildup from reaching a level that could lead to thermal events or other forms of damage which affect the performance of an individual battery module, thereby affecting the overall function of the vehicle as the vehicle power source is damaged. A thermal runaway occurs when the heat buildup is beyond the venting capabilities of the structures incorporated into the module bay and/or the enclosure of the battery module. In the event that thermal runaway occurs, battery containers, possibly including battery packs, that rely on insufficient venting will end up experiencing a complete failure as the heat will continue to build up and propagate throughout the entire battery pack ultimately affecting all of the battery modules in the battery pack.

Other approaches rely on silicone-based gasket material between the individual battery cells of battery modules within a battery container, possibly including one or more battery packs, which may be applied as a foam. A silicone-based foam can be used primarily for sealing the collective battery cells against moisture and contaminants while also serving as a manner to fix the collective battery cells in place within a battery module assembly. In some approaches, the silicone-based foam may be non-flammable. This approach also fails to address the thermal runaway condition. Although the silicone-based foam may not be flammable itself, the silicone-based foam once cured does not provide any alleviation of heat that builds up in an individual battery module as a result of use or failure of a subset of battery cells and does not prevent the propagation of heat throughout a battery container and/or battery pack to a collection of battery modules. In the event some or all of the battery cells are producing enough heat to trigger a thermal runaway event, the silicone-based foam does not provide a mechanism to alleviate the heat build-up and will not prevent the eventual failure of the entire battery pack as a result of the progressive failure of each battery module within the battery pack as a result of the thermal runaway event.

In view of the foregoing, systems and methods are described herein for enabling thermal isolation of individual battery modules within a battery container and/or battery pack using, for example, intumescent material. In some embodiments, a battery container comprises two opposing side walls and a crossmember extending between inner surfaces of the two opposing side walls. The crossmember partially defines (e.g., separates, encapsulates, and/or supports) a first module bay and/or enclosure on a first side of the crossmember and a second module bay and/or enclosure on the second side of the crossmember. A gap resides between the first and second module bays and/or enclosures. Intumescent material may be positioned proximate to the gap. The intumescent material is configured to expand when heated to create at least a partial seal in the gap between the first and second module bays and/or enclosures, at least partially isolating the battery modules positioned in each respective module bay and/or enclosure. In some embodiments, the intumescent material will expand as a result of heat exposure and is positioned such that an individual module bay and/or enclosure will be sealed off from the rest of the battery module during a thermal runaway event.

These techniques solve the problems of other approaches described above. The battery container and/or battery pack may be arranged such that individual battery modules are positioned in separate module bays and/or enclosures that are defined, for example, by separating walls such that not all of the battery cells or modules are in a single module bay and/or enclosure. Should an individual battery module be operating at a condition that leads to a thermal runaway event, the individual battery module will be sealed off from the rest of the battery modules in the battery container and/or battery pack by intumescent material positioned proximate to any gaps between module bays and/or enclosures holding the different battery modules. Thus, while a single module bay and/or enclosure and an individual battery module may be compromised as a result of the thermal runaway event, the remaining battery modules, module bays, and/or enclosures are separated, isolated, and/or protected so as to not be subjected to the thermal runaway condition and the battery pack can remain operational without the remaining battery modules being affected by the event experienced by the isolated battery module.

Intumescent materials may comprise materials that swell as a result of exposure to heat, increasing temperatures, hot air or gases, among other possibilities and change density to prevent the transfer of heat from a heat source to areas external to the heat source as separated by the intumescent material. By positioning intumescent material such that it seals off module bays and/or enclosures with individual battery modules, while a single module bay and/or enclosure may be comprised, the remaining module bays and/or enclosures will not be at risk or be subjected to the same thermal runaway event as in other approaches.

An additional benefit of the incorporation of intumescent materials into a sealing interface is that the intumescent materials are configured to only activated under certain conditions. For example, in thermal events that do not arise to the thermal runaway condition, the battery container may be configured to incorporate venting structures to reduce pressure and vent gasses without creating internal conditions that lead to the activation of the intumescent material. Considering this additional venting structures, the activation conditions of the intumescent materials can be tuned. Another benefit of the incorporation of intumescent materials into the sealing interfaces is that intumescent materials have an activation period which serves to create a delay in forming a rapid seal before some of the gas and pressure can escape. By having an activation period, the intumescent materials prevents an excessive pressure rise which mitigates structural stress on the battery container once the seal is completely formed.

In some embodiments, the intumescent material may be a foam that lines the walls that define the module bays and/or enclosures within the battery container and/or battery pack.

In some embodiments, the intumescent material may be a collection of strips that each have at least one adhesive surface so that they remain affixed to the walls that partially define the module bays and/or enclosures within the battery container and/or battery pack.

In some embodiments, the opposing side walls that at least partially define the module bays and/or enclosures of the battery container and/or battery pack are lined with intumescent material comprising a collection of strips while other portions are lined with intumescent material consisting of a foam. For example, some portions of the walls include uneven tabs and surfaces for where they are connected to either a cover or base member that also partially define the plurality of module bays and/or enclosures. The more irregular surfaces may be lined with foam which will expand according to the shape of the surroundings and may fill in the irregularities created by the shape of the connecting surfaces between the walls and the cover or base member. In another example, there may be clearly defined level portions where the walls and either the cover or base member connect (e.g., between holes arranged to receive fasteners or pins to secure a wall to either the cover or base member). A strategically sized strip may be placed on the level surface and provide a complete seal based on the shape of the level surface between features.

In some embodiments, a gap is formed by the crossmember and may include an opening between the crossmember and the base member. In some embodiments, each module bay and/or enclosure has a first gap between the crossmember and the base member and a second gap between at least a pair of battery modules positioned in each module bay and/or enclosure. Each gap may have intumescent material positioned proximate to each gap to isolate each module bay and/or enclosure from each other and each module within each module bay and/or enclosure from each other. For example, the intumescent material may be positioned such that it is making contact with either the surface of the cross member or the base member so that when it is exposed to heat it expands to make contact with a surface opposing the surface the intumescent material was initial positioned on. In some embodiments, the first gap is an opening in the crossmember through which a set of tubes extend. The tubes may be lines used to distribute coolant throughout the battery container and/or battery pack and the gap may also be used to create a drain path for fluid within the battery container and/or battery pack.

In some embodiments, each of the opposing walls defining the pair of module bay and/or enclosures may include at least one opening corresponding to each module bay and/or enclosure at least partially defined by the crossmember. Each opening may be structured to enable the passive venting of heat generated by battery modules from within the module bay and/or enclosure to a channel embedded in the opposing side walls of the battery container and/or battery pack which may lead to an opening at the back end of the battery container and/or battery pack.

In some embodiments, opposing walls of the battery container and/or battery pack may include at least one valve which when exposed to thermal runaway conditions enable rapid venting of heat generated by the battery modules within each of the module bays and/or enclosures to the environment surrounding the battery container and/or battery pack. For example, at least one battery module within an individual module bay and/or enclosure may operate at conditions that create a runaway condition. Intumescent material lining the module bay and/or enclosure may create a seal to prevent initial propagation of the heat generated by the battery module within the module bay and/or enclosure from escaping and exposing other battery modules in other module bays and/or enclosures to the same conditions. In order to vent the heat and avoid fatigue of the seal created by the intumescent material, valves arranged to be embedded in the opposing walls facing the environment of the battery module may physically deform to create an opening from within the sealed module bay and/or enclosure to the environment surrounding the battery container and/or battery pack to enable rapid egress of the heat generated during the runaway event.

In some embodiments, an insulation material may be arranged to be positioned between the top of the battery modules within each module bay and/or enclosure and a cover to further reduce the passage of heat, generated from one of battery modules, from the area within an individual module bay and/or enclosure to the remainder of the module bays and/or enclosures of the battery container and/or battery pack. For example, the insulation sheet may be made of a ceramic material and may be a thickness that is the distance from the top of a battery module to the lowest protruding feature. The insulation sheet prevents the conduction of heat, as it is generated by individual battery modules, by the cover so that it is not transferred to other module bays and/or enclosures with other battery modules to ensure the isolation of a thermal runaway event to a single module bay and/or enclosure.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 illustrates an example of a battery container with a plurality of module bays and/or enclosures that are each lined with intumescent material, in accordance with some embodiments of the disclosure;

FIG. 2 illustrates an example of a battery container with a plurality of module bays and/or enclosures that have battery modules positioned in each bay and/or enclosure and are lined with intumescent material between battery modules and along a crossmember that partially defines each bay and/or enclosure, in accordance with some embodiments of the disclosure;

FIG. 3A illustrates an example a battery container with a plurality of module bays and/or enclosures with a plurality of openings structured to enable the egress of heat generated by battery modules in each respective bay and/or enclosure into a channel in each of the opposing side walls that partially define each respective bay and/or enclosure, in accordance with some embodiments of the disclosure;

FIG. 3B illustrates an example of a battery container with a plurality of module bays and/or enclosures with a plurality of venting structures embedded in the opposing walls that partially define each of the module bays and/or enclosures that are structured to mechanically deform when exposed to thermal runaway conditions, in accordance with some embodiments of the disclosure;

FIG. 4 illustrates an example of a venting structure that is structured to mechanically deform when exposed to thermal runaway conditions, in accordance with some embodiments of the disclosure;

FIG. 5 illustrates an example of a battery container with a pair of opposing walls connected by a plurality of crossmembers defining a plurality of module bays and/or enclosures, in accordance with some embodiments of the disclosure;

FIG. 6 illustrates an example of a cross section of a battery container with a battery module encased between a pair of crossmembers, a cover, and a base member with a layer of insulation positioned between the top of the battery module and the cover, in accordance with some embodiments of the disclosure;

FIG. 7 is a flow chart representing an illustrative process for assembling a battery container structured to isolate battery modules within the battery container during thermal events, in accordance with some embodiments of the disclosure; and

FIG. 8 shows a schematic diagram of an illustrative vehicle system comprising a vehicle body and a battery container, in accordance with some embodiments of the disclosure.

### DETAILED DESCRIPTION

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

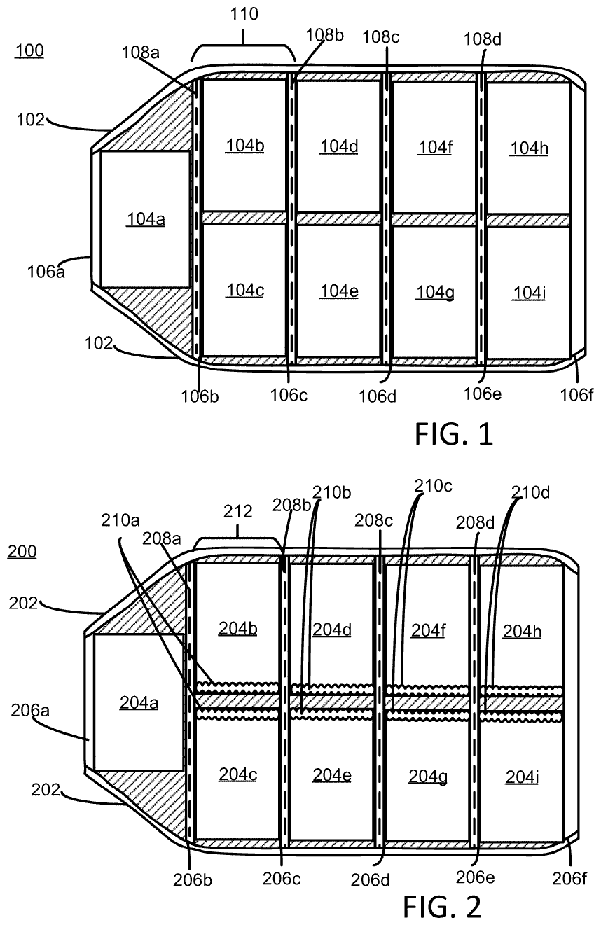

FIG. 1 illustrates battery container and/or battery pack 100 with a plurality of module bays and/or enclosures that are each lined with intumescent material, in accordance with some embodiments of the disclosure. The battery container 100 may include one or more battery packs and/or battery modules. For example, the battery container 100 may include one or more module bays, where the module bays include the battery modules. Further, each module bay may have one or more enclosures that encompass, surround, and/or border the one or more battery modules. In some embodiments, one or more parts of or the entirety of battery container 100 is configured as an assembly or system implementing various features, processes, and components of FIGS. 2-8. Although FIG. 1 shows a certain number of components, in various examples, battery container 100 may include fewer than the illustrated number of components and/or multiples of one or more of the illustrated components.

Battery container 100 is enclosed by opposing side walls 102. Opposing side walls 102 house the internal components of battery container 100 and have a pair of inner surfaces. Between opposing side walls 102 are battery modules 104a-i. Each of battery modules 104a-i comprise a subset of a plurality of battery cells configured to provide power to a vehicle having a set of vehicle systems. Battery container 100 is divided into a plurality of module bays and/or enclosures by crossmembers 106a-f. For example, a first module bay and/or enclosure may be formed by crossmember 106a and crossmember 106b. Bay 110 illustrates an example of a first module bay and/or enclosure as defined by opposing side walls 102 and cross members 106b and 106c. Within the first module bay and/or enclosure, first battery module 104a is positioned. In another example, a second module bay and/or enclosure may be formed by crossmember 106b and crossmember 106c. Within the second module bay and/or enclosure, second battery module 104b and third battery module 104c are positioned. In some embodiments, a plurality of battery modules may be positioned between each pair of crossmembers. Battery container 100 includes intumescent material portions 108a-d. Intumescent material portions 108a-d (represented by dashed lines) are positioned along the length of each of crossmembers 106b-e. In some embodiments, the crossmembers at the opposing ends of battery container 100 are not lined with portions of intumescent material (e.g., crossmember 106a and 106f may not have portions of intumescent material applied along the length of the crossmember). Not shown in FIG. 1 is a battery container cover that is positioned above crossmembers 106b-e. One or more gaps may exist between each of crossmembers 106b-e and the battery container cover and the portions of intumescent material may be positioned proximate to the gaps.

FIG. 2 illustrates battery container and/or battery pack 200 with a plurality of module bays and/or enclosures that have battery modules positioned in each module bay and/or enclosure and are lined with intumescent material between battery modules and along the crossmember that partially defines each module bay and/or enclosure, in accordance with some embodiments of the disclosure. In some embodiments, one or more parts of or the entirety of battery container 200 is configured as an assembly or system implementing various features, processes, and components of FIGS. 1 and 3A-8. Although FIG. 2 shows a certain number of components, in various examples, battery container 200 may include fewer than the illustrated number of components and/or multiples of one or more of the illustrated components.

Battery container 200 is enclosed by opposing side walls 202. Opposing side walls 202 house the internal components of battery container 200 and have a pair of inner surfaces. Between opposing side walls 202 are battery modules 204a-i. Each of battery modules 204a-i comprise a subset of a plurality of battery cells configured to provide power to a vehicle having a set of vehicle systems. Battery container 200 may be divided into a plurality of module bays and/or enclosures by crossmembers 206a-f. For example, a first module bay and/or enclosure may be formed by crossmember 206a and crossmember 206b. Bay 212 illustrates an example of a first module bay and/or enclosure as defined by opposing side walls 202 and cross members 206b and 206c. Within the first module bay and/or enclosure, first battery module 204a may be positioned. In another example, a second module bay and/or enclosure may be formed by crossmember 206b and crossmember 206c. Within the second module bay and/or enclosure, second battery module 204b and third battery module 204c are positioned. In some embodiments, a plurality of battery modules is positioned between each pair of crossmembers. Battery container 200 includes intumescent material portions 208a-d. Intumescent material portions 208a-d (represented by dashed lines) are positioned along the length of each of crossmembers 206b-e. In some embodiments, the crossmembers at the opposing ends of battery container 200 are not lined with portions of intumescent material (e.g., crossmember 206a and 206f may not have portions of intumescent material applied along the length of the crossmember).

Battery container 200 includes a second set of portions of intumescent material that separate each of battery modules 204b, 204d, 204f, and 204h from battery modules 204c, 204e, 204g, and 204i, respectively. Secondary intumescent material portions 210a-d are applied to the inner faces of battery modules 204b-i (e.g., above and/or below the inner faces) and are positioned to prevent the propagation of heat across an individual module bay and/or enclosure as partially defined by each of crossmembers 206b-e. In some embodiments, the secondary intumescent material portions 210a-d are applied to only a single inner battery module face per module bay and/or enclosure (e.g., to the inner face of battery module 204b or 204c). In some embodiments, either of intumescent material portions 208a-d and 210a-d are at least one of an intumescent foam or an intumescent strip. For example, some portions of the walls include uneven tabs and surfaces for where they are connected to either a cover or base member that also partially define the plurality of module bays and/or enclosures. In some embodiments, the more irregular surfaces may be lined with foam which will expand according to the shape of the surroundings and may fill in the irregularities created by the shape of the connecting surfaces between the walls and the cover or base member. In another example, there may be clearly defined level portions where the walls and either the cover or base member connect (e.g., between holes arranged to receive fasteners or pins to secure a wall to either the cover or base member). A strategically sized strip may be placed on the level surface and provide a complete seal based on the shape of the level surface between features.

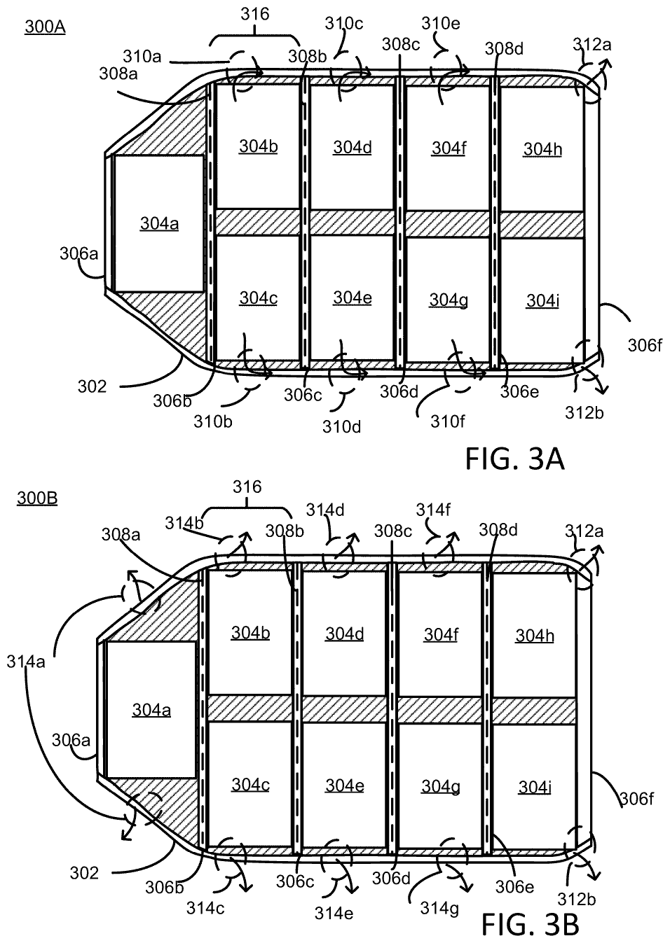

FIG. 3A illustrates battery container and/or battery pack 300A with a plurality of module bays and/or enclosures with a plurality of openings structured to enable the egress of heat generated by battery modules in each respective module bay and/or enclosure into a channel in each of the opposing side walls that partially define each respective module bay and/or enclosure, in accordance with some embodiments of the disclosure. In some embodiments, one or more parts of or the entirety of battery container 300A may be configured as an assembly or system implementing various features, processes, and components of FIGS. 1, 2, 3B-8. Although FIG. 3A shows a certain number of components, in various examples, battery container 300A may include fewer than the illustrated number of components and/or multiples of one or more of the illustrated components.

Battery container 300A is enclosed by opposing side walls 302. Opposing side walls 302 house the internal components of battery container 300A and have a pair of inner surfaces. Between opposing side walls 302 are battery modules 304a-i. Each of battery modules 304a-i comprise a subset of a plurality of battery cells configured to provide power to a vehicle body with a set of vehicle systems. Battery container 300A is divided into a plurality of module bays and/or enclosures by crossmembers 306a-f. For example, a first module bay and/or enclosure may be formed by crossmember 306a and crossmember 306b. Bay 316 illustrates an example of a first module bay and/or enclosure as defined by opposing side walls 302 and cross members 306b and 306c. Within the first module bay and/or enclosure, first battery module 304a is positioned. In another example, a second module bay and/or enclosure may be formed by crossmember 306b and crossmember 306c. Within the second module bay and/or enclosure, second battery module 304b and third battery module 304c are positioned. In some embodiments, a plurality of battery modules is positioned between each pair of crossmembers. Battery container 300A includes intumescent material portions 308a-d. Intumescent material portions 308a-d (represented by dashed lines) are positioned along the length of each of crossmembers 306b-e. In some embodiments, the crossmembers at the opposing ends of battery container 300A are not lined with portions of intumescent material (e.g., crossmember 306a and 306f may not have portions of intumescent material applied along the length of the crossmember).

Battery container 300A is divided into module bay and/or enclosures by crossmembers 306a-f. Embedded in opposing side walls 302 are venting openings 310a-f. Each of venting openings 310a-f corresponding to an individual module bay and/or enclosure with a pair of battery modules (e.g., battery modules 304b and 304c). A channel is positioned within opposing side walls 302 and venting openings 310a-f enable the egress of heat and pressure generated by battery modules 304b-g out of the respective module bays and/or enclosures and towards exhaust structures 312a and 312b. Exhaust structures 312a and 312b are positioned towards the rear of battery container 300A and are positioned to vent heat propelled through the channels in opposing side walls 302 to the environment surrounding battery container 300A.

FIG. 3B illustrates battery container and/or battery pack 300B with a plurality of module bays and/or enclosures with a plurality of venting structures embedded in the opposing walls that partially define each of the module bays and/or enclosures that are structured to mechanically deform when exposed to thermal runaway conditions, in accordance with some embodiments of the disclosure. In some embodiments, one or more parts of or the entirety of battery container 300B is configured as an assembly or system implementing various features, processes, and components of FIGS. 1-3A and 4-8. Although FIG. 3B shows a certain number of components, in various examples, battery container 300B may include fewer than the illustrated number of components and/or multiples of one or more of the illustrated components.

Battery container 300B is enclosed by opposing side walls 302. Opposing side walls 302 house the internal components of battery container 300B and have a pair of inner surfaces. Between opposing side walls 302 are battery modules 304a-i. Each of battery modules 304a-i comprise a subset of a plurality of battery cells configured to provide power to a drive unit in a vehicle body with a set of vehicle systems. Battery container 300B is divided into a plurality of module bays and/or enclosures by crossmembers 306a-f. For example, a first enclosure may be formed by crossmember 306a and crossmember 306b. Bay 316 illustrates an example of a first module bay and/or enclosure as defined by opposing side walls 302 and cross members 306b and 306c. Within the first enclosure, first battery module 304a is positioned. In another example, a second enclosure may be formed by crossmember 306b and crossmember 306c. Within the second enclosure, second battery module 304b and third battery module 304c are positioned. In some embodiments, a plurality of battery modules is positioned between each pair of crossmembers. Battery container 300B includes intumescent material portions 308a-d. Intumescent material portions 308a-d (represented by dashed lines) are positioned along the length of each of crossmembers 306b-e. In some embodiments, the crossmembers at the opposing ends of battery container 300B are not lined with portions of intumescent material (e.g., crossmember 306a and 306f may not have portions of intumescent material applied along the length of the crossmember).

Battery container 300B is divided into enclosures by crossmembers 306a-f. Embedded in opposing side walls 302 are venting structures 314a-g. Each of venting structures 310b-g corresponds to an individual module bay and/or enclosure with a pair of battery modules (e.g., battery modules 304b and 304c). Each of venting structures 310a-g are embedded in opposing side walls 302 such that at least one of each corresponds to the individual module bays and/or enclosures as partially defined by crossmembers 306a-f. In some embodiments, venting structures 310a-g are structured to mechanically fail when exposed to thermal runaway conditions to create an opening corresponding to a module bay and/or an enclosure where an individual battery module may experience thermal runaway conditions to enable the egress of heat and pressure generated by at least one of battery modules 304a-g out of one of venting structures 314a-g. In some embodiments, venting structures 314a-g are also paired with exhaust structures 312a and 312b which are positioned towards the rear of battery container 300A and are positioned to vent heat propelled towards the back end of battery container 300B out to the environment surrounding battery container 300B.

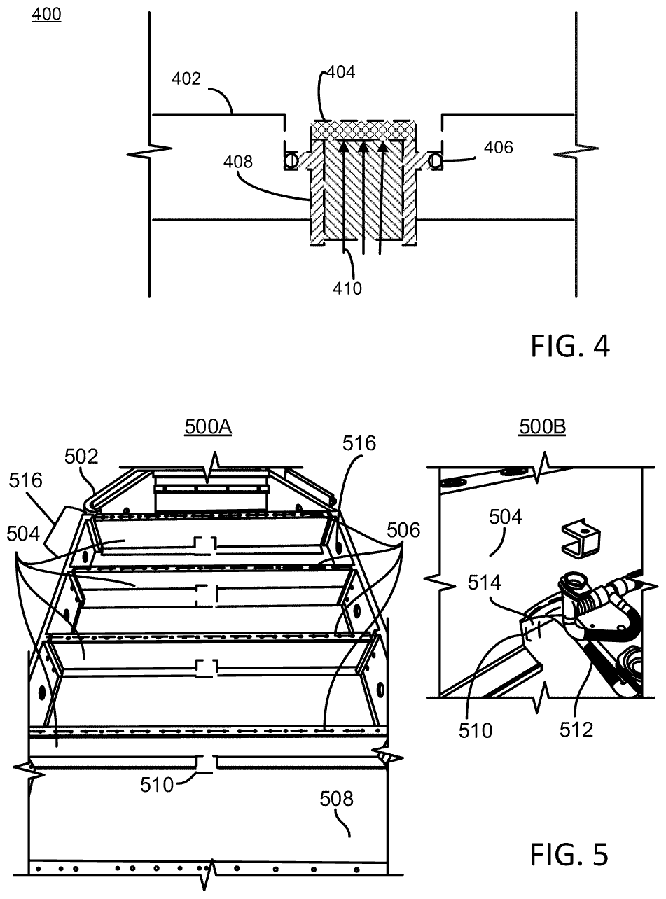

FIG. 4 illustrates venting structure 400 that is structured to mechanically deform when exposed to thermal runaway conditions, in accordance with some embodiments of the disclosure. In some embodiments, one or more parts of or the entirety of venting structure 400 is configured as an assembly or system implementing various features, processes, and components of FIGS. 1-3B and 5-8. Although FIG. 4 shows a certain number of components, in various examples, venting structure 400 may include fewer than the illustrated number of components and/or multiples of one or more of the illustrated components.

Venting structure 400 may be embedded in wall 402. Wall 402 may represent a wall of a plurality of walls represented by any of opposing side walls 102, 202, or 302 of FIGS. 1-3B. Venting structure 400 may be configured such that in its final adjusted position the entire assembly that comprises venting structure 400 does not protrude through a plane defined by the outer surface of wall 402. A top-most portion of burst disk assembly 400 may be deformable portion 404. Deformable portion 404 may be structured to create a seal to inhibit the ingress of fluids from the environment from entering each of module bays and/or enclosures which may be at least partially defined by crossmembers 106a-f, 206a-f, or 306a-f of FIGS. 1-3B. Deformable portion 404 may be structured to deform and create an opening when exposed to a heat flow corresponding to a thermal runaway condition which enables heat flow 410 to exit to an environment defined by wall 402 (e.g., may melt and create an opening when exposed to a thermal runaway condition as created by at least one battery module in a battery pack). For example, deformable portion 404 when it deforms may leave a visual indication of a thermal event either by a color change or other residue remaining as a result of the event in addition to an open space where deformable portion 404 was located prior to deforming as a result of being exposed to the thermal runaway event.

Radial sealing ring 406 may be situated in a groove to create a seal against the sidewalls created by the opening to situate venting structure 400. Radial seal ring 406 may be comprised of any material that is known to seal against the ingress of fluids to a battery pack such as battery containers 100, 200, 300A, and 300B of FIGS. 1-3B (e.g., water). Threaded portion 408 may be situated below radial seal ring 406 and may match the threaded portion of wall 402 to enable positioning of venting structure 400 within wall 402 to prevent deformable portion 404 from protruding beyond a plane defined by the surrounding outer surface. Deformable portion 404 may be comprised of any material suitable to create a seal to prevent fluids or gas from entering a battery pack such as those included in the battery containers 100, 200, 300A, and 300B of FIGS. 1-3B based on the anticipated environment of a battery pack while also being made of a material structured to deform and create an opening when exposed to a thermal runaway event. The egress of heat is depicted by heat flow 410. In some embodiments, deformable portion 404 may incorporate structural elements to enable the egress of heat without deforming to reduce the risk of a thermal runaway event by enable passive venting.

FIG. 5 illustrates battery container 500A with a pair of opposing walls connected by a plurality of crossmembers, including features depicted in crossmember 500b, defining a plurality of module bays and/or enclosures, in accordance with some embodiments of the disclosure. In some embodiments, one or more parts of or the entirety of battery container 500A and crossmember 500b are configured as assemblies or systems implementing various features, processes, and components of FIGS. 1-4, and 6-8. Although FIG. 5 shows a certain number of components, in various examples, battery container 500A and crossmember 500b may include fewer than the illustrated number of components and/or multiples of one or more of the illustrated components.

Battery container 500A is enclosed by opposing side walls 502. Opposing side walls 502 house the internal components of battery container 500A and have a pair of inner surfaces. Between opposing side walls 502 are spaces for battery modules. Battery container 500A is divided into a plurality of module bays and/or enclosures by crossmembers 504. For example, a first module bay and/or enclosure may be formed by first and second adjacent crossmembers 504. Bay 516 illustrates an example of a first module bay and/or enclosure as defined by opposing side walls 502 and a first pair of cross members 504. Within the first module bay and/or enclosure, a first battery module and second battery module may be positioned. Battery container 500A includes intumescent material portions 506. Intumescent material portions 506 are positioned along the length of each of crossmembers 504. In some embodiments, the crossmembers at the opposing ends of battery container 500A are not lined with portions of intumescent material (e.g., the end most crossmembers may not have portions of intumescent material applied along the length of the crossmember).

Bottom member 508 further defines each of the module bays and/or enclosures that are at least partially defined by opposing side walls 502 and crossmembers 504. For example, a pair of battery modules may be positioned on top of bottom member 508 for each respective module bay and/or enclosure as partially defined by crossmembers 504 and each of crossmember 504 may be secured to bottom member 508. At the bottom of each of crossmembers 504, there may be gap 510. Gap 510 may provide a channel to position a set of coolant lines or may be used to direct drainage of liquid that accrues throughout battery container 500A. Crossmember 500B is an example of one of crossmembers 504 which includes gap 510 and tubes 512. Positioned proximal to gap 510 is intumescent material portion 514. In some embodiments, intumescent material portion 514 is arranged to prevent the propagation of heat between module bays and/or enclosures by creating a complete seal in gap 510 when exposed to a thermal runaway condition. Venting feature 516 depicts one of either venting openings 310a-f of battery container 300A of FIG. 3A or venting structures 314a-g of battery container 300B of FIG. 3B. Venting feature 516 is embedded in opposing side walls 502 and enables the egress of heat and pressure as generated by battery module positioned in each of the module bays and/or enclosures that are at least partially defined by crossmember 504.

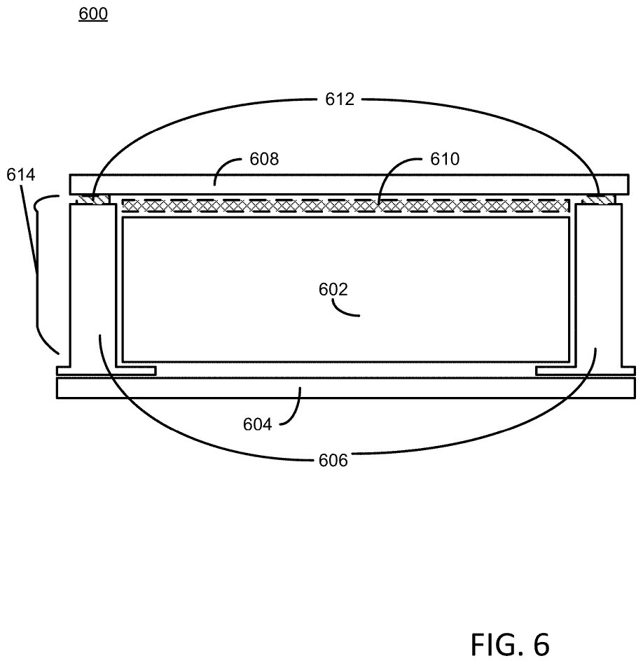

FIG. 6 illustrates a cross section of battery container 600 with a battery module encased between a pair of crossmembers, a cover, and a base member with a layer of insulation positioned between the top of the battery module and the cover, in accordance with some embodiments of the disclosure. In some embodiments, one or more parts of or the entirety of battery container 600 is configured as an assembly or system implementing various features, processes, and components of FIGS. 1-5, 7 and 8. Although FIG. 6 shows a certain number of components, in various examples, battery container 600 may include fewer than the illustrated number of components and/or multiples of one or more of the illustrated components.

Battery container 600 includes battery module 602 which is positioned above bottom member 604 and is enclosed by crossmembers 606. Crossmembers 606 connect with bottom member 604 to form a module bay and/or an enclosure in which battery module 602 is positioned. Enclosure 614 illustrates an example of a first module bay and/or enclosure as defined in part by cross members 602, bottom member 604, and cover 608. Cover 608 is positioned above crossmembers 606 and battery module 602 to create a closed structure which defines a module bays and/or enclosure of battery container 600. Between the top-most portion of battery module 602 and cover 608 is insulation layer 610. In some embodiments, insulation layer 610 may be a ceramic material structure to prevent the propagation of heat from battery module 602 to cover 608. Positioned on top of cross members 606 and below cover 608 are intumescent material portions 612 that expand when exposed to heat corresponding to a thermal runaway condition (e.g., when battery module 602 overheats).

A thermal runaway event can manifest within the battery container and/or battery pack as a direct result of the heat generated from battery cells within the battery modules. Between the operation of the vehicle and the current draw from battery cells to power the systems of the vehicle (e.g., 20-30 W continuous power output for 5-15 minutes), the conditions within the battery pack can change such that heat may build up at a significantly faster rate (e.g., build up at such a rate such that the exterior of the battery cell reaches temperatures exceeding 180° C.). For example, the battery cells in battery module 304c of FIG. 3A may experience damage, be fatigued, or be overdrawn as a result of supporting a particular portion of the vehicle system. As the result, heat is generated from battery module 304c. In response to the heat being generated and being of a magnitude and rate corresponding to a thermal runaway event, intumescent material 306b and 306c will expand to isolate the module bay and/or enclosure holding battery modules 304b and 304c from the remaining battery modules within the battery pack. Once the module bays and/or enclosure is sealed, heat may primarily escape from venting opening 310b. In the event some of the heat from the thermal runaway event propagates across the module bay and/or enclosure to the opposing wall, heat may also escape from venting opening 310c so as to prevent the seal created by the intumescent material from fatiguing and to also prevent battery module 304b, as well as the remaining battery modules in the assembly, from being adversely affected by the event which started at battery module 304c.

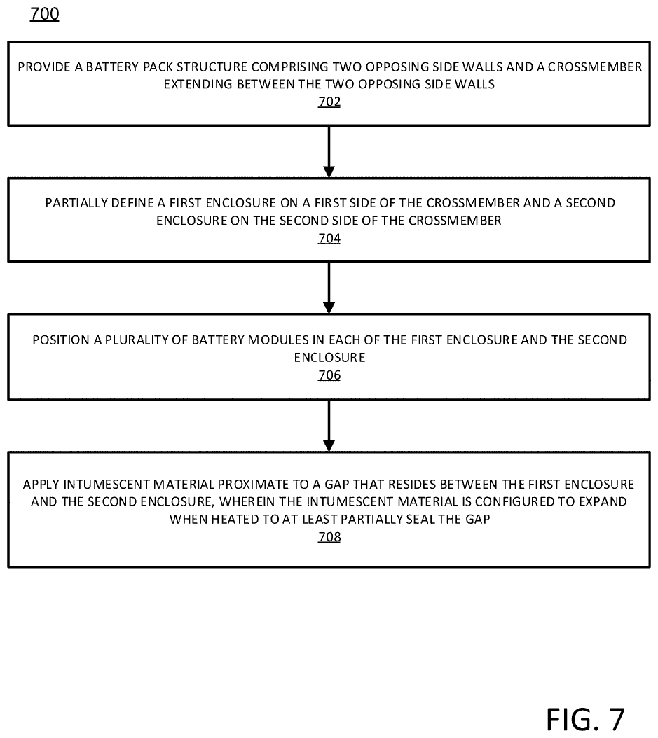

FIG. 7 is a flow chart representing assembly process 700 for assembling a battery container, possibly including one or more battery packs, structured to isolate battery modules within the battery container during thermal events, in accordance with some embodiments of the disclosure. In some embodiments, one or more parts of or the entirety of assembly process 700 incorporates various features, processes, and components of FIGS. 1-6 and 8. Although FIG. 7 shows a certain number of steps, in various examples, assembly process 700 may include fewer than the illustrated number of components and/or multiples of one or more of the illustrated components.

At 702, a battery container structure comprising two opposing side walls and a crossmember extending between the two opposing side walls is provided. The battery container structure may be any one of or any combination of battery container 100, 200, 300A, 300B, 500A, or 600 of FIGS. 1-3B, 5, and 6, respectively. At 704, a first module bay and/or enclosure is partially defined on a first side of the crossmember and a second module bay and/or enclosure is partially defined by a second side of the crossmember. At 706, a plurality of battery modules is positioned in each of the first enclosure and the second module bay and/or enclosure. At 708, intumescent material is positioned proximate to a gap that resides between the first and the second module bays and/or enclosures. The intumescent material is configured to expand when heated to at least partially seal the gap.

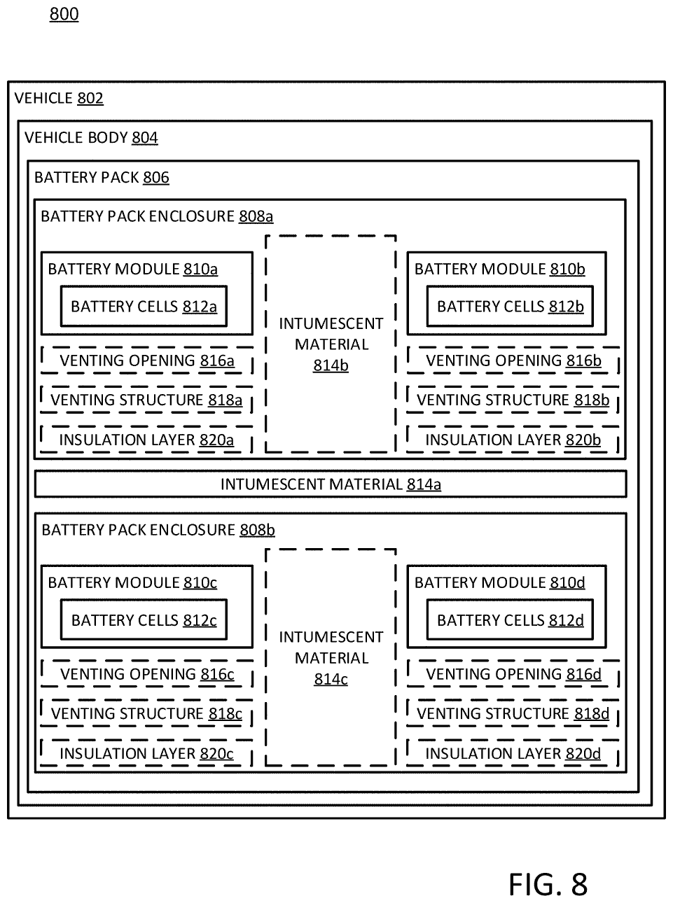

FIG. 8 shows vehicle system 800 comprising vehicle 802, vehicle body 804, and battery container 806, in accordance with some embodiments of the disclosure. In some embodiments, one or more parts of or the entirety of vehicle system 800 is configured as an assembly or system implementing various features, processes, and components of FIGS. 1-7. Although FIG. 8 shows a certain number of components, in various examples, vehicle system 800 may include fewer than the illustrated number of components and/or multiples of one or more of the illustrated components.

Vehicle system 800 includes vehicle 802, which corresponds to a motorized vehicle with various suspension and powertrain configurations. Vehicle 802 includes vehicle body 804, which corresponds to a vehicle chassis and other subcomponents configured to interface with a vehicle powertrain. Included in or attached to vehicle body 804 is at least one of battery container 806. Battery container 806 is divided into module bays and/or enclosures 808a and 808b. Battery container 806 may be any one of or any combination of battery containers 100, 200, 300A, 300B, 500A, or 600 of FIGS. 1-3B, 5, and 6, respectively. Battery pack bays and/or enclosures 808a and 808b are separated by intumescent material 814a. In some embodiments, intumescent material 814a may be positioned on top of a crossmember as depicted in any one of or any combination of battery containers 100, 200, 300A, 300B, 500A, or 600 of FIGS. 1-3B, 5, and 6, respectively.

Within battery module bay and/or enclosure 808a are battery modules 810a and 810b. Battery modules 810a and 810b include subsets of battery cells 812a and 812b, respectively. In some embodiments, separating each of battery modules 810a and 810b may be intumescent material portion 814b. In some embodiments, each of the separated portions of battery pack bay and/or enclosure 808a may include at least one of venting opening 816a and 816b, venting structure 818a and 818b, or insulation layer 820a and 820b. Each of these features corresponds to venting openings 310a-g of FIG. 3A, venting structures 314a-g of FIG. 3B, and insulation layer 610 of FIG. 6, respectively.

Within battery module bay and/or enclosure 808b are battery modules 810c and 810d. Battery modules 810c and 810d include subsets of battery cells 812c and 812d, respectively. In some embodiments, separating each of battery modules 810c and 810d may be intumescent material portion 814c. In some embodiments, each of the separated portions of battery pack bay and/or enclosure 808b may include at least one of venting opening 816c and 816d, venting structure 818c and 818d, or insulation layer 820c and 820d. Each of these features corresponds to venting openings 310a-g of FIG. 3A, venting structures 314a-g of FIG. 3B, and insulation layer 610 of FIG. 6, respectively.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A battery container, comprising:
a crossmember separates a first module bay on a first side of the crossmember and a second module bay on a second side of the crossmember,
wherein the first module bay and the second module bay are each configured to hold one or more battery modules; and
intumescent material configured to expand between the first module bay and the second module bay.

2. The battery container of claim 1, further comprising a gap between the first and second module bays, and wherein the intumescent material comprises a foam that expands to seal the gap between the first module bay and the second module bay.

3. The battery container of claim 1, wherein the intumescent material comprises a strip, and wherein the strip comprises an adhesive surface.

4. The battery container of claim 1, further comprising a plurality of crossmembers, wherein the plurality of crossmembers partially define the first and second module bays.

5. The battery container of claim 4, wherein portions of the intumescent material is positioned proximate to a plurality of gaps between a plurality of module bays, wherein each of the plurality of module bays is configured to hold the one or more battery modules.

6. The battery container of claim 1, further comprising:
a base member positioned below the crossmember; and
a cover positioned above the crossmember.

7. The battery container of claim 6, further comprising a gap between the crossmember and the base member.

8. The battery container of claim 7, wherein the crossmember comprises an opening forming the gap at a bottom portion of the crossmember adjacent to the base member.

9. The battery container of claim 8, wherein the intumescent material is positioned proximate to the opening in the crossmember through which the set of tubes extends.

10. The battery container of claim 6, wherein the gap comprises a first gap, wherein the intumescent material comprises first intumescent material, wherein the first module bay comprises a first battery module and a second battery module spaced apart from each other, wherein a second gap resides between the first battery module and the cover, wherein second intumescent material is positioned proximate to the second gap, and wherein the second intumescent material is configured to expand when heated to at least partially isolate the first battery module from the second battery module within the first module bay.

11. The battery container of claim 1, wherein each of the two opposing side walls comprises:
a first opening on an inner surface of the first module bay;
a second opening on an inner surface of the second module bay; and
an internal channel coupled to the first and second openings, wherein the internal channel provides egress of heat and pressure from each of the first and second openings to a venting structure.

12. The battery container of claim 1, wherein each of the two opposing side walls comprises:
a first venting structure on an inner surface corresponding to the first module bay, wherein the first venting structure enables the egress of heat and pressure from within the first module bay to the environment surrounding the battery container; and
a second venting structure on an inner surface corresponding to the second module bay, wherein the second venting structure enables the egress of heat and pressure from within the second module bay to the environment surrounding the battery container.

13. The battery container of claim 1, further comprising an insulation layer positioned between a battery module and the cover.

14. A vehicle system, comprising:
a battery pack comprising:
two walls;
a crossmember extending between the two walls, wherein:
the crossmember partially defines a first enclosure and a second enclosure;
the first enclosure and the second enclosure are each configured to hold one or more of battery modules; and
a gap resides between the first and second enclosures; and
intumescent material positioned proximate to the gap and wherein the intumescent material is configured to expand when heated to at least partially seal the gap.

15. The vehicle system of claim 14, wherein the battery pack further comprises a plurality of crossmembers, wherein the plurality of crossmembers partially define a plurality of enclosures.

16. The vehicle system of claim 15, wherein portions of the intumescent material are positioned proximate to a plurality of gaps between the plurality of enclosures, wherein each of the plurality of enclosures is configured to hold one or more of battery modules.

17. The vehicle system of claim 14, wherein each of the two opposing side walls comprises:
a first opening on the inner surface corresponding to the first enclosure;
a second opening on the inner surface corresponding to the second enclosure; and
an internal channel coupled to the first and second openings, which enables egress of heat and pressure from each of the first and second openings to a venting structure.

18. The vehicle system of claim 14, wherein each of the two opposing side walls comprises:
a first venting structure on the inner surface corresponding to the first enclosure, wherein the first venting structure enables the egress of heat and pressure from within the first enclosure to the environment surrounding the battery pack; and
a second venting structure on the inner surface corresponding to the second enclosure, wherein the second venting structure enables the egress of heat and pressure from within the second enclosure to the environment surrounding the battery pack.

19. The vehicle system of claim 14, further comprising an insulation layer positioned between a battery module and a cover, wherein the cover is positioned above the two opposing side walls and the crossmember.

20. A method for assembling a battery container, the method comprising:
providing a battery container structure comprising two walls and a crossmember extending between the two walls, wherein:
the crossmember partially defines a first module bay and a second module bay;
the first module bay and the second module bay are each configured to hold a plurality of battery modules; and
a gap resides between the first and second module bays;
applying intumescent material proximate to the gap, wherein the intumescent material is configured to expand when heated to at least partially seal the gap.
